(19) United States
(12) Patent Application Publication
(10) Pub. No.: US 2004/0146398 A1
(43) Pub. Date: Jul. 29, 2004

(54) Assembly arrangement for blades with adjustable setting

(75) Inventors: Alain Bromann, Vulaines (FR); Philippe Pabion, Vaux le Penil (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, PARIS (FR)

(21) Appl. No.: 10/756,780

(22) Filed: Jan. 14, 2004

(30) Foreign Application Priority Data
Jan. 17, 2003 (FR) 0300476

(51) Int. Cl. F03B 1/04

(52) U.S. Cl. 415/148

(57) ABSTRACT

The pivots (2) of the blades (1) comprise removable portions (16) located at their outer end and adjustable in height using a thread (17) or a similar means in order to adjust the distance between the head (9) of a lever (10) controlling the adjustment of the blade and the casing (4) or the collar (8) of a bearing (5); if the centring bushings (7) of the bearings (5 and 6) are worn, harmful tilting of pivots (2) will be limited by a stop for the head (9).

The subject of this invention is an assembly arrangement for blades with adjustable setting.

Blades with adjustable setting mean blades fixed to the stator of a turbo-machine and that can be pivoted to modify the guiding characteristics that they impose on the gas flow and thus adjust the machine to its different speeds. These blades are fitted with pivots passing through the casing at their outer ends, and these pivots are retained by bearings enabling rotation, and the arrangement also includes levers engaged on portions of the pivots outside the casing. These levers are usually joined to a common control ring, that goes around the casing and that turns all levers, pivots and the blades themselves as it rotates.

In the usual design, the outside portions of the pivots have a square cross-section and the heads of the levers have a square recess. Inserting the square section in the square recess in the lever entrains the pivots and these blades in rotation. A nut is screwed to the threaded end of the pivots to hold the heads of the levers in position under all circumstances.

When the bearings become worn, the pivots can tilt in the holes in the casing, possibly causing damage as a result of friction between elements of the mobile assembly and the casing or the rotor. And large gas leaks can sometimes be observed even when the bearings are in better condition. This is why an attempt was made to find an improved set-up in which these disadvantages are reduced. The essential characteristic of the new assembly is that the existing clearance between the casing and the lever heads can be adjusted, and that gas leaks can be reduced by reducing this clearance, and to provide better resistance to tilting of the pivots due to the additional support provided by the lever head.

In the future, external portions of blade pivots are divided into two parts connected by an axial position adjustment means for varying the length of the external portions; one of the parts of the pivots which is removable and that carries the threaded end into which the retaining nut is engaged, comprises a lever stop; and the levers are clamped between the stops and the nuts. Thus, a change to the setting between the two parts of the pivot effectively modifies the distance between the casing and the removable portion of the pivots, and therefore between the casing and the lever.

One convenient means of connection between the two end parts of the pivots is a thread.

These aspects of the invention and others will now be described with reference to

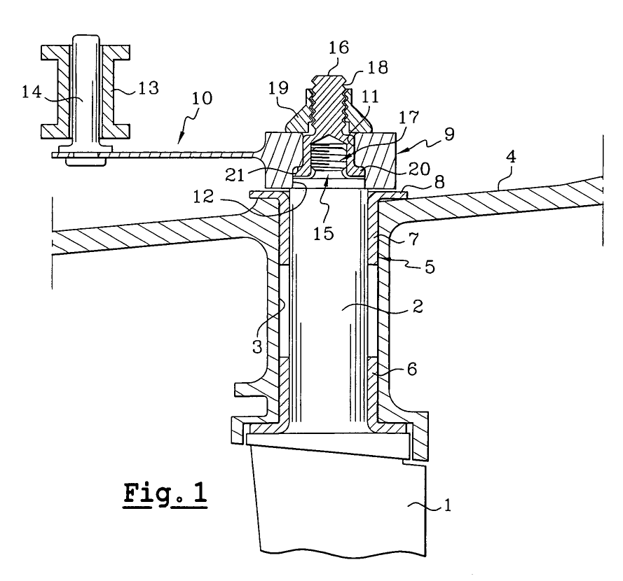

FIG. 1 that shows the invention in general, and

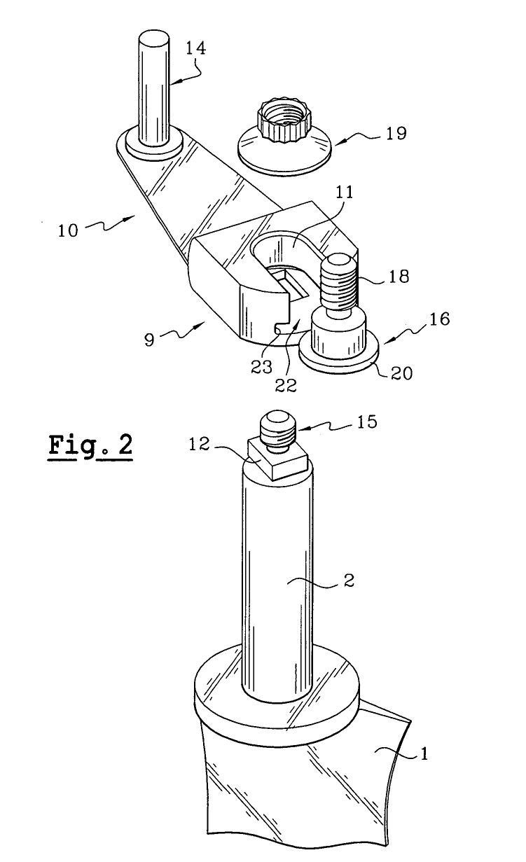

FIG. 2 that shows an exploded view of a particular embodiment.

FIG. 1 shows the outside portion of a blade 1, together with its pivot 2 that extends through a hole 3 in a casing 4 to the outside of the casing. A pair of bearings 5 and 6 supports the pivot 2 at the ends of the hole 3, and the bearings 5 and 6 comprise an annular bushing assigned to the centring of pivot 2 in the hole 3, and also a flat portion 8 arranged around the ends of the hole 3 and limiting movements of the assembly without allowing direct contact between the blade 1 and the internal end of hole 3 or between the casing 4 and a head 9 of a control lever 10. This lever 10 extends outside the casing 4 and its head 9 is provided with a housing 11 in which the end of the pivot is engaged. The housing 11 has a square section 12, or more generally a polygonal section over part of its height, and the section of the pivot 2 at this location is complementary so that it can be rotated by tilting the lever 10. This is achieved using a control ring 13 not shown in detail but that is concentric with the stator 4. The lever 10 carries a spindle 14 at its end opposite the head 9 and that penetrates into the ring 13. As the ring rotates, the spindle 14 moves and the lever 10 rotates.

Characteristically, the square section 12 only extends at the bottom of the housing 11, and in particular the end of the pivot 2 is divided into two portions, one end 15 of which is fixed to the main portion of the pivot 2 (that is located in the hole 3) but with a smaller radius, while the other portion 16 is removable and covers the previous portion to which it is connected adjustably by a thread 17. The removable portion 16 carries the usual threaded end 18 of blade pivots and the retaining nut 19 engaged around this end.

Furthermore, the removable portion 16 comprises a stop 20 in the form of an external collar at its lower end, and the housing 11 is provided with a step 21 that stops in contact with the collar 20. Screwing the nut 19 tightens the head 9 between the nut and the stop 20 and therefore holds the head 9 on the removable portion 16 at a fixed and determined height. Furthermore, the removable portion 16 was adjusted using the thread 17 to a height above the other portion 15 chosen such that the clearance between the bottom of the head 9 and the flat part 8 of the outer bearing 5 is very much reduced. Thus, an accidental tilting of the pivot 2 when the bearings 5 and 6 are worn immediately causes contact between the head 9 and the portion 8, limiting this tilting. In this design, the square section 12 extends under the removable portion 16 and the stop 20.

There is no particular difficulty in assembling the assembly and the removable portion 12 may in particular be set-up passing below the housing 11. Another solution is possible, as shown in FIG. 2 in which a notch 22 passes through the head 9 as far as the housing 11 and in a direction transverse to this housing so that it becomes possible to install the removable portion 16 by making it pass through the notch 22 when the lever 10 is already in position, the head 9 on the pivot 2, simply by lifting the lever 10 slightly so that the removable portion 16 passes above the other end portion 15. The notch 22 comprises a widened region 23 in which the stop 20 fits, wider than the remainder of the removable portion 16.

1. Assembly arrangement (1) of blades with adjustable setting, comprising blade pivots (2) passing through a casing (4), control levers (10) engaged on portions of the pivots outside the casing, and nuts (19) screwed onto threaded ends (18) of the outside portions, heads (11) of levers (10) being retained between the nuts and the casing, characterised in that the outside portions are divided into two parts (15, 16) connected by an axial position adjustment means (17) for varying the length of the external portions, one of the said parts (16) of the pivots which is removable carries the threaded end and comprises a lever stop (20), the levers (10) being clamped between the stops and the nuts.

2. Assembly arrangement of blades with adjustable setting according to claim 1, characterised in that the position adjustment means is a thread.

3. Assembly arrangement of blades with adjustable setting according to any one of claims 1 or 2, characterised in that levers comprises notches (22) for inserting the removable parts (16) in a direction transverse to lever housings (11) through which these levers are engaged on the outside portions of the pivots, the notches comprising widened regions (23) in which the stops (20) fit.
